(19) United States
(12) Patent Application Publication
(10) Pub. No.: US 2012/0097793 A1
(43) Pub. Date: Apr. 26, 2012

(54) SURROUND FOR AN OPENING MADE IN AN AIRCRAFT PANEL, AND METHOD OF FITTING IT

(75) Inventors: Frederic Fort, Saint Genies Bellevue (FR); Laurent Gauthie, Tournefeuille (FR)

(73) Assignee: AIRBUS OPERATIONS S.A.S., Toulouse Cedex 9 (FR)

(21) Appl. No.: 13/280,461

(22) Filed: Oct. 25, 2011

(30) Foreign Application Priority Data
Oct. 26, 2010 (FR) 1058792

(51) Int. Cl. B64C 1/00; B23P 11/00

(52) U.S. Cl. 244/129.1; 29/428

(57) ABSTRACT

The subject of the invention is a surround for an opening made in a panel of an aircraft, notably a fuselage panel of the aircraft. The panel comprises at least one exterior surface, the surround is fixed to the panel, forming an interface for fitting a closing-off device, and comprises at least one lip extending towards the centre of the opening. The lip supports the closing-off device and has at least one external face interposed between the external surface of the panel and the closing-off device. The surround is characterized in that it is made of at least two independent components joined together, a first component comprising the lip and a second component being fixed to the panel.

### BACKGROUND OF THE INVENTION

The present invention relates to the design of the surround for an opening made in a panel of an aircraft and to the method of fitting surround.

The structure of an aircraft generally comprises several panels through which are made openings that are closed off by elements that may or may not be transparent.

FIG. 1 illustrates, in cross section, a known arrangement of a surround 10 for an opening 12 made in an aircraft fuselage panel 14 being fitted with a window 16. Thus, according to this prior art, the surround 10 used to attach the window-pane 18/window-sill 20 assembly to the opening 12 consists of a single surround component 22 in the form of an angle section straddling the edge 24 of the opening 12.

More specifically, the base 26 of the component 22 has a heel 28 that fits into the opening 12, and a horizontal part 30 pressed against the edge 24 of the opening 12 and fixed to the panel 14.

The heel 28 comprises a lip 34 extending towards the centre of the opening 12 to support the window-pane 18/window-sill 20 assembly, while a retaining device 33, that rests against a vertical extension 32 of the horizontal part 30, clamps the assembly from the other side.

In order to maintain the aerodynamic qualities of the fuselage, the surround 10 supporting the window 16 has to lie in the continuity of the aerodynamic surface.

In order to achieve this, the height H of the heel 28 of the component 22 has to be substantially equal to the thickness E of the panel 14 so that the heel lies flush with the exterior surface 36 of the panel 14.

Thus the height H of the heel 28 of the component 22 is dependent on the thickness E of the panel 14.

The components 22 are used extensively across an aircraft and across different types of aircrafts and therefore not every panel is likely to have the same thickness E.

Hence, in order to prevent the surrounds of the various openings in an aircraft being offset towards the outside of the aircraft, it is necessary to have a large number of families of surround components 22 with heels 28 of different heights in order to maintain the aerodynamic continuity of the fuselage. With this prior-art design of a surround, many different surround components 22 have to be assigned part numbers and used to build an aircraft.

To illustrate the scale of the problem, certain aircraft need up to twenty-one families of surrounds.

In addition, in the case of an aircraft manufacturer, the number of different surround component 22 part numbers increases correspondingly with the number of types of aircraft.

Thus, in this prior-art design of surround 10 the dependency of the height H of the heel 28 of the surround component 22 on the thickness E of the panel 14 is a major disadvantage that prevents any marrying of one and the same surround component 22 with the various openings of one and the same types of aircraft or different types of aircraft.

### BRIEF SUMMARY OF THE INVENTION

The present invention aims to alleviate the problems and disadvantages of the prior art.

According to an embodiment of the invention, a surround design may be married with different thicknesses of panels, namely allowing the flushness of the surround to be adjusted with respect to the exterior surface, notably the aerodynamic surface, of the panels.

An embodiment includes a surround for an opening made in a panel of an aircraft, notably a fuselage panel of the aircraft. The panel comprises at least one exterior surface. The surround may be fixed to the panel, forming an interface for fitting a closing-off device, and may comprise at least one lip extending towards the centre of the opening. The lip supports the closing-off device and has at least one external face interposed between the exterior surface of the panel and the closing-off device. The surround is made of at least two independent components joined together, a first component comprising the lip and a second component fixed to the panel.

According to another aspect of the invention, a method of fitting is provided, which makes the surround easier to use and to marry the openings made in panels of different thicknesses.

Prior to being joined together, the first and second components may slide relative to one another in the direction of the thickness of the panel.

Thus, and still before the components are joined together, it is possible to adjust the position and therefore the flushness of the external face of the first component with respect to the exterior surface of the panel.

Thus, because the two-part design of the surround according to an embodiment of the invention is no longer dependent on the thickness of the panel, identical surround components can be used on openings made in panels of different thicknesses, thus making it possible to greatly reduce the number of families of surround needed for building an aircraft, especially in the case of an aircraft manufacturer who makes different models of aircraft.

According to another embodiment of the invention, a surround design allows the functions of supporting the window pane and window sill to be separated from the functions of mechanically stabilizing the edge of the opening made in the panel.

In the surround according to this embodiment of the invention, the first component performs the function of supporting the closing-off device, such as a blanking plate or a window pane, while the second component provides the mechanical stabilizing of the edge of the opening.

Thus, the mechanical properties of each of the components can be optimized separately.

### BRIEF DESCRIPTION OF THE DRAWINGS

Further features and advantages will emerge from the following description of the invention, which description is given solely by way of example and with reference to the attached drawings in which:

FIG. 1 is a view in cross section of a surround according to the prior art;

FIG. 2 is an exploded perspective view of the two components of a surround according to an embodiment of the invention before they are joined together;

FIGS. 3A and 3B illustrate the adaptability of the surround according to the invention to suit panels of different thicknesses; and

FIG. 4 illustrates an exploded perspective view of the two components of a surround according to a second embodiment of the invention before they are joined.

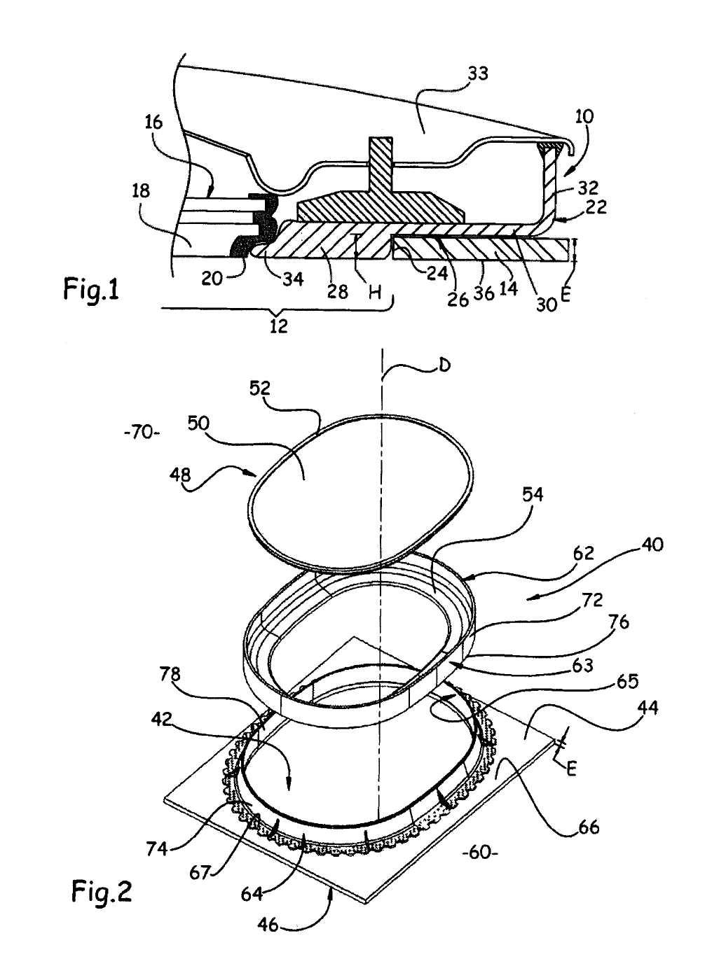

### DETAILED DESCRIPTION

In one embodiment illustrated in FIG. 2, the surround 40 is to be fitted to an opening 42 of oblong shape made in the substantially planar panel 44 of an aircraft.

The panel 44 is a fuselage panel the exterior surface 46 of which corresponds to the aerodynamic surface of the aircraft and the surround forms an interface for fitting a closing-off device 48 in the form of at least one window pane 50 equipped with a periphery seal 52 to form a window.

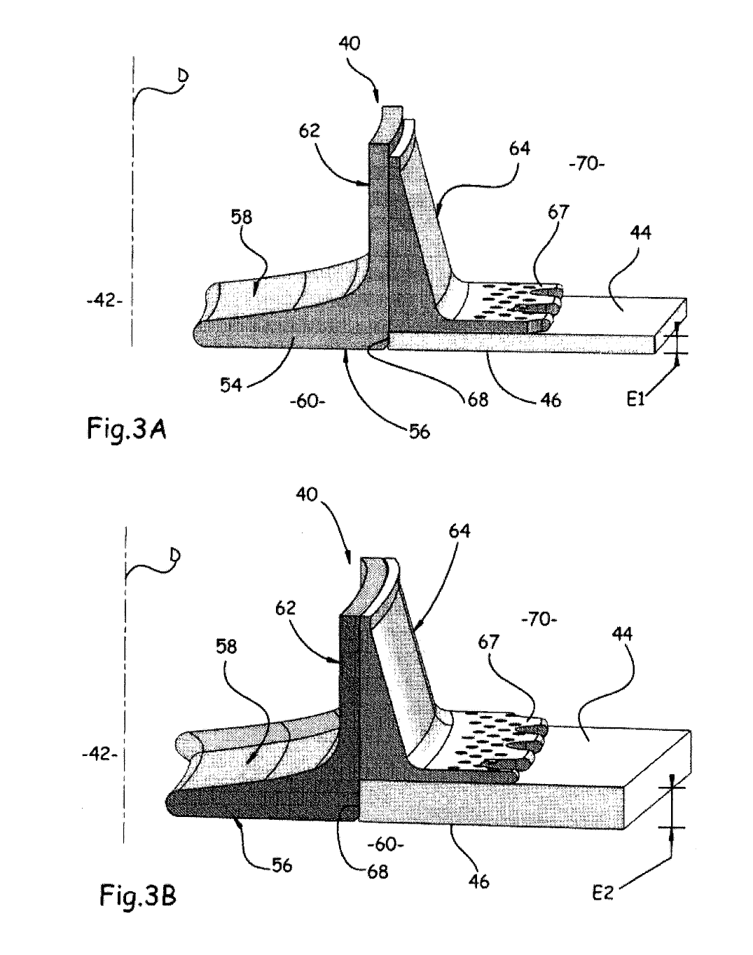

As illustrated in FIGS. 2, 3A and 3B, the surround 40 surrounds the entire circumference of the opening 42, is fixed to the panel 44, and comprises at least one lip 54 extending towards the centre of the opening 42, the lip 54 supporting the window 48 and being able to react the cabin pressurizing forces applied to the window.

In greater detail, the lip 54 has at least one external face 56 interposed between the exterior surface 46 of the panel and the window 48, and also has an internal face 58 against which the window pane 50 and its peripheral seal 52 rest.

The internal face 58 is inclined towards the centre of the opening 42 and towards the outside 60 of the panel to make the window pane 50 easier to position and the seal 52 easier to compress.

The external face 56 of the lip 54 extends substantially in a continuation of the exterior surface 46 of the panel 44 in order to maintain the aerodynamic continuity of the fuselage.

The surround 40 is made of at least two independent components joined together, a first component 62 comprising the lip 54 and a second component 64 fixed to the panel, preferably by a fastening device such as rivets.

More specifically, because the panel also comprises an interior surface 66, the second component 64 comprises a base 67 fixed to the interior surface at the edge 68 of the opening 42.

Advantageously, the second component 64 thus acts as a reinforcement mechanically stabilizing the edge 68 of the opening as the fuselage flexes and therefore as the panel 44 deforms.

The base 67 may be serrated and perforated to save weight.

In the remainder of the description, the panel 44 has a thickness E, and an axis D, indicating the direction of the thickness E, is substantially perpendicular to the panel.

To make it possible to adjust the flushness of the external face 56 of the first component 62 with respect to the exterior surface 46 of the panel 44, and before the two components (62, 64) of the surround are joined together, the first component 62 is mounted so that it can slide with respect to the second component 64.

To do this, the first component 62 comprises at least one gliding surface 63 and the second component 64 comprises at least one gliding surface 65, the gliding surfaces (63, 65) being capable of sliding one against the other in the perpendicular direction D to the panel.

In an exemplary embodiment of the invention, the first component 62 comprises at least one wall called a first wall 72 extending in the perpendicular direction D and towards the inside 70 of the panel 44, and the second component 64 comprises at least one wall called a second wall 74 extending in the perpendicular direction D and towards the inside 70 of the panel 44, the walls (72, 74) being back to back and of substantially identical height.

The first wall 72 is mounted on the inside of the second wall 74, the internal face 78 of the wall second 74 substantially corresponding to the gliding surface 65, and the external face 76 of the first wall 72 substantially corresponding to the gliding surface 63.

As a result, the components (62, 64) have cross sections substantially in the shape of an L placed back to back.

Advantageously, the walls (72, 74) also act as stiffeners increasing the moment of inertia of the surround 40 and further improving the mechanical stabilizing of the edge 68 of the opening 42.

Hence, before the components (62, 64) are joined together at the walls (72, 74) by fixing means, the external face 76 of the first wall 72 glides against the internal face 78 of the second wall 74.

For preference, the internal face 78 of the second wall 74 lies in the continuation of or protrudes beyond the edge 68 of the opening 42, and the external face 76 of the first wall 72 also slides along the edge 68 before the components (62, 64) are joined together. In order to avoid problems with sealing and if the method of manufacture of the components (62, 64) so permits, the external 76 and internal faces are produced to precise dimensions with tight geometric tolerances so that there is minimal sliding clearance between them.

In addition, sealing means, such as a seal, are applied between the faces (76, 78) of the components.

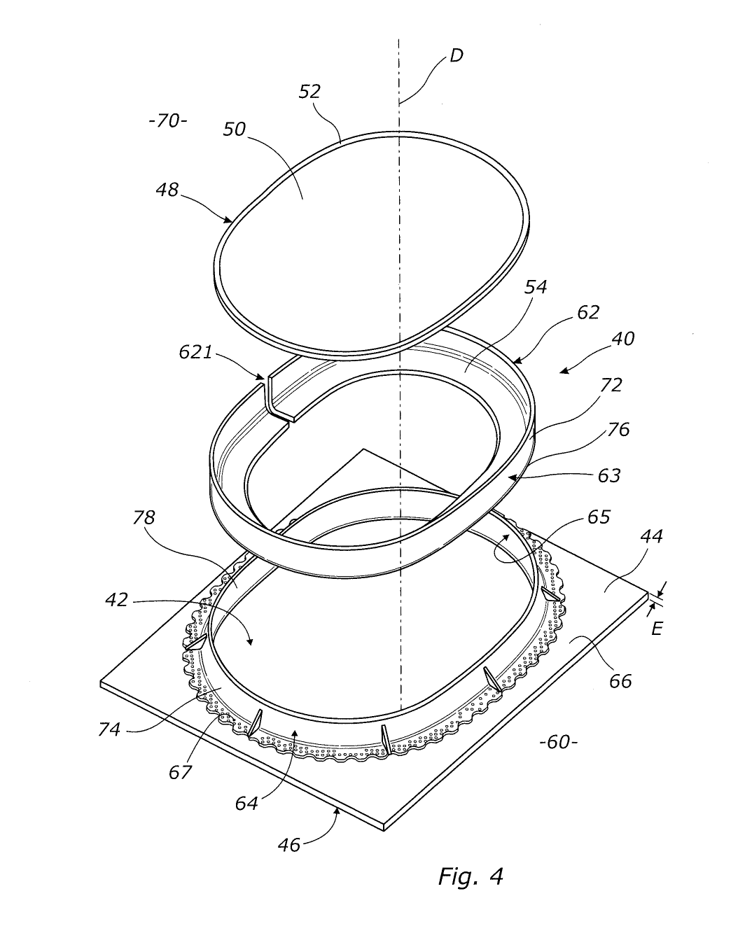

However, according to another embodiment of the surround 40 which is aimed at eliminating the clearance between the components (62, 64), and notably if the method of manufacture is unable to achieve tight geometric tolerances, one of the components (62, 64) is split transversely along its entire section and additional sealing means are applied at the split. For example, referring to FIG. 4, component 62 includes a transverse split 621 along its entire section and additional means are applied at the split 621. It will, of course, be understood that in an alternative embodiment, component 64 may include a transverse split along its entire section and additional sealing means may be applied at the split.

For preference, and notably in the case of a closing-off device 48 in the form of a window, the lip 54 is designed so that the closing-off device 48 lies flush with the external face 56 of the first component 62 or is inset towards the inside 70 of the panel 44.

In any of the embodiments of the surround 40 which have been described hereinabove, the first and second components (62, 64) may be made of a metal or composite.

In the case of the use of a composite, the components (62, 64) may preferably be obtained by an injection-moulding process capable of achieving tight geometric tolerances.

Again in any of the embodiments of the surround 40 which have been described hereinabove, and in order best to maintain the aerodynamic continuity of the fuselage, a method of fitting the surround generally makes provision for the position of the first component 62 to be adjusted with respect to the second component 64 and to the panel 44 in the direction D according to the thickness E of the panel when the surround 40 is fitted and before the components are joined together.

More specifically, the method of fitting makes provision for the external face 56 of the first component 62 to lie flush with the exterior surface 46 of the panel 44 or to be inset towards the inside 70 of the panel.

Thus, and as illustrated by way of comparison in FIGS. 3A and 3B, the two same components (62, 64) of a surround 40 can be adapted to suit openings 42 made in panels 44 of different thicknesses (E1, E2), thus making it possible to reduce the number of part numbers needed for building each model of aircraft.

Thereafter, the method of fitting makes provision for the position of the first component 62 with respect to the second component 64 to be adjusted according to the desired degree to which the closing-off device 48 is to be inset with respect to the exterior surface 46 of the panel 44, namely the aerodynamic surface.

To achieve this, the method of fitting the surround 40 first of all makes provision for the second component 64 to be fixed to the panel 44, then for the first component 62 to be positioned with respect to the second according to the desired degree to which the closing-off device 48 is to be inset, before the fixing means that join the components (62, 64) together at their respective walls (72, 74) are brought into operation.

For preference, the fixing means are brought into operation by drilling through the two components (62, 64) together at their respective walls (72, 74) when fitting the surround 40 onto the opening 42, the drillings thus obtained accepting fixing means such as screws or rivets, the fixing means being sized and distributed in the walls (72, 74) in such a way as best to transfer the pressure forces experienced by the window 48 and reacted by the first component 62 to the second component 64.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A surround for an opening made in a panel of an aircraft, the panel comprising at least one exterior surface, the surround being fixed to the panel, forming an interface for fitting a closing-off device, and comprising at least one lip extending towards the centre of the opening, the lip supporting the closing-off device and having at least one external face interposed between the exterior surface of the panel and the closing-off device, wherein the surround is made of at least first and second independent components joined together, a first component comprising the lip and a second component fixed to the panel.

2. The surround for an opening made in a panel of an aircraft according to claim 1, wherein, before the first and second components of the surround are joined together, the first component is fitted so that it can slide with respect to the second component.

3. The surround for an opening made in a panel of an aircraft according to claim 2, wherein the first component comprises at least one gliding surface and the second component comprises at least one gliding surface, the gliding surfaces being capable of sliding one against the other in a direction of the thickness (E) of the panel, called a perpendicular direction (D).

4. The surround for an opening made in a panel of an aircraft according to claim 3, wherein, the first component comprises at least a first wall extending in the perpendicular direction (D) and towards the inside of the panel, the second component comprises at least a second wall extending in the perpendicular direction (D) and towards the inside of the panel, the first wall is mounted on the inside of the second wall, the external face of the second wall corresponds to the gliding surface, and the internal face of the first wall corresponds to the gliding surface.

5. The surround for an opening made in a panel of an aircraft according to claim 4, wherein the internal face of the first wall lies in the continuation of or extends beyond the edge of the opening.

6. The surround for an opening made in a panel of an aircraft according to claim 1, wherein one of the first and second components is transversely split along its entire section.

7. A method of fitting a surround according to claim 1, wherein it makes provision for the position of the first component to be adjusted with respect to the second component and to the panel in the perpendicular direction (D) according to the thickness (E) of the panel when the surround is being fitted and before the components are joined together, the external face of the first component lying flush with the exterior surface of the panel or being inset towards the inside of the panel.

8. The method of fitting a surround according to claim 7, wherein it makes provision for the position of the first component with respect to the second component to be adjusted according to the desired extent to which the closing-off device is to be set in with respect to the exterior surface of the panel.

9. The method of fitting a surround according to claim 8, wherein it makes provision for the second component to be fixed to the panel and then for the first component to be positioned with respect to the second component according to the desired extent to which the closing-off device is to be inset, before fixing means that join the components together at their respective walls are brought into use.

10. The method of fitting a surround according to claim 9, wherein the fixing means are brought into operation by drilling through the two components together at their respective walls when fitting the surround onto the opening, the drillings obtained accepting fixing means comprising screws or rivets.
